(19) United States
(12) Patent Application Publication
(10) Pub. No.: US 2008/0241269 A1
(43) Pub. Date: Oct. 2, 2008

(54) Methods of Applying Antimicrobial Formulations on Food

(75) Inventor: David J. Velasquez, Cannon Falls, MN (US)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY

(21) Appl. No.: 12/064,528

(22) PCT Filed: Aug. 22, 2006
(86) PCT No.: PCT/US06/32793

§ 371 Date: Feb. 22, 2008

Related U.S. Application Data
(60) Provisional application No. 60/710,628, filed on Aug. 23, 2005.

(51) Int. Cl. A01N 63/02; A01P 3/00

(52) U.S. Cl. 424/520

(57) ABSTRACT

Methods for applying antimicrobials or other active agents onto food products, and particularly meat products, are described. The methods apply a controlled amount of treatment composition to the food product in an efficient fashion so that an excess of the solution is not required.

### BACKGROUND

Food borne diseases cause significant illness and death each year, with direct and indirect medical costs estimated by some sources to be over 1 billion a year. Common food pathogens include Salmonella, Listeria monocytogenes, Escherichia coli 0157:H7, Campylobacter jejuni, Bacillus cereus, and Norwalk-like viruses. Outbreaks of food borne diseases typically have been associated with contaminated meat products, raw milk, or poultry products but fruits and vegetables can also serve as sources of food borne illness.

Treatment of fresh food products for the purpose of improving edibility, longevity, and/or appearance is primarily directed to the removal of surface contamination. Fresh food products, including meats (e.g., beef, pork, poultry, etc.), seafood (e.g., fish and shellfish), fruits, and vegetables, are susceptible to surface contamination by various microorganisms, some of which are pathogenic. Improper cooking, as well as the spread of microorganisms via physical transfer to hands, food handling surfaces, and other foods, can result in gastrointestinal disorders that, in some cases, lead to death. Also, fungi and bacteria can deleteriously affect the appearance, taste, and smell of a variety of food products.

The rate of bacterial and fungal proliferation and resulting damage and health risk can, to some extent, be diminished by refrigeration, but there is a limit to the degree of refrigeration that can be imposed on meat, poultry, seafood, fruit, and vegetable products. Furthermore, some bacteria such as psychrophiles can survive and even flourish at temperatures approaching the freezing point. It is thus advantageous to control, destroy, or deactivate microbial and fungal contaminants during processing to reduce the initial population of organisms and/or fungi on the surface of food products.

In an effort to reduce surface contamination, a variety of disinfecting and fungicidal chemical treatments have been applied to the surfaces of food products. Compositions used to reduce the microbial contamination in and on food as well as other surfaces have typically involved use of materials such as oxidizing agents including ozonated water, hydrogen peroxide, peracetic acid, acidified sodium chlorite, aqueous chlorine, etc.; quaternary ammonium surfactant compositions such as those based on cetylpyridinium chloride or benzalkonium chloride; phenolic compounds; aqueous solutions of organic carboxylic acids such as citric and lactic acid, and formaldehyde solutions that at higher concentrations may affect the properties of the surface treated. Compositions using fatty acid monoesters have been used in recent years to reduce microbial load on food such as poultry as described in U.S. Pat. Nos. 5,460,833 and 5,490,992; and fruit and vegetables as described in publication WO 200143549A.

However, methods of applying such treatments are either inefficient in terms of utilization of the chemicals so as to minimize waste, or are ineffective, or simply not feasible. For example, food products, regardless of their size, can be effectively treated for surface contamination by microorganisms or fungi by dipping or otherwise being immersed in a bath or tank containing the appropriate chemical solution. However, this method has a number of drawbacks, including poor control of absorption, and the use of large volumes of chemicals.

Methods for treating surface contamination of food products by spray application of disinfecting and fungicidal chemical solutions are also known in the art. For example, a basic approach is to convey whole or partial animal carcasses past a plurality of spray applicators (i.e., nozzles) dispensing disinfectant while otherwise keeping the carcasses substantially immobilized (i.e., suspended from hooks). The entire surface, including interior surfaces of opened body cavities, can be effectively treated, given a sufficient number of spray applicators properly positioned and delivering a sufficient quantity of solution by means of effective spray patterns (see, e.g., U.S. Pat. No. 4,849,237 to Hurst).

Tumblers are also well known in the art of processing food products. The product is agitated by being “churned” in a drum which rotates about a substantially horizontal axis, while being sprayed with a liquid which may be a coolant, likes those described in U.S. Pat. Nos. 6,318,112 (Lennox) and 6,228,172 (Taylor, et al.); an antimicrobial solution such as those described in U.S. Pat. No. 6,896,921 (Groves, et al.) and U.S. Publication No. 2005/0058013 (Warf et. al); or a powder material such as that described in U.S. Pat. No. 6,511,541 (Pentecost). Tumblers may be used in batch mode, food being loaded in batches into the tumbler, sprayed and then discharged from the tumbler, or they may be arranged as continuous devices in which the food is fed into one end of the cylindrical drum, travels along the drum in an axial direction while being sprayed and then is discharged from the other end of the drum.

Within these systems, control of product movement is typically not directed to each piece of product; rather, control of movement is directed to moving the batch of food as a whole. Furthermore, many of these tumbler designs require extensive floor space which is often not available in many production facilities.

There remains a need in the art for improved housing structure and methods for the efficient and effective application of antimicrobial treatment to foods that can be readily integrated within a processing plant.

### SUMMARY

The present invention is directed to methods for applying antimicrobials or other active agents onto food-products, and particularly meat products. In one aspect, a method of treating food product with an treatment composition is provided, comprising loading the food product into a housing structure, wherein the housing structure has at least one baffle that causes the food product to rotate as the housing structure is agitated; spraying the food product with an treatment composition as the food product rotates; wherein the treatment composition sprayed on the food product is no more than 5 wt % based on the combined weight of the food product and the treatment composition in the housing structure; and wherein at least 90% of the surface area of the food product is coated with the treatment composition as determined by % Surface Coverage Test.

In another aspect, a method of treating food product with an treatment composition is provided comprising loading the food product into a housing structure, wherein the housing structure has at least one baffle that causes the food product to rotate as the housing structure is agitated, spraying the food product with an treatment composition as the food product rotates; wherein the treatment composition sprayed on the food product is no more than 5 wt % based on the combined weight of the food product and the treatment composition in the housing structure; and wherein the treatment composition reduces the microorganisms on the surface of the food product by at least one log.

In another aspect, a method of treating food product with an treatment composition is provided comprising loading the food product into a housing structure, wherein the housing structure has at least one baffle that causes the food product to rotate as the housing structure is agitated; spraying the food product with an treatment composition in more than one spray pulse interval as the food product rotates; wherein the treatment composition sprayed on the food product is no more than 5 wt % based on the combined weight of the food product and the treatment composition in the housing structure; wherein at least 1% of the total amount of treatment composition sprayed on the food product is delivered within one spray pulse interval; and wherein at least 90% of the surface area of the food product is coated with the treatment composition as determined by % Surface Coverage Test.

In a further aspect, a method of treating food product with an treatment composition is provided comprising loading the food product into a housing structure, wherein the housing structure has at least one baffle that causes the food product to rotate as the housing structure is agitated; spraying the food product with an treatment composition as the food product rotates; wherein the treatment composition sprayed on the food product is no more than 5 wt % based on the combined weight of the food product and the treatment composition in the housing structure; wherein at least 1% of the total amount of treatment composition sprayed on the food product is delivered within one spray pulse interval; and wherein at least 90% of the surface area of the food product is coated with the treatment composition as determined by % Surface Coverage Test.

In another aspect, a method of treating food product with an treatment composition is provided comprising loading the food product into a housing structure, wherein the housing structure has at least one baffle that causes the food product to rotate as the housing structure is agitated; wherein the housing structure has a tumbling efficiency of at least 48; spraying the food product with an treatment composition in more than one spray pulse interval as the food product rotates; wherein the treatment composition sprayed on the food product is no more than 5 wt % based on the combined weight of the food product and the treatment composition in the housing structure; and wherein at least 90% of the surface area of the food product is coated with the treatment composition as determined by % Surface Coverage Test.

In another aspect, a method of treating food product with an treatment composition is provided comprising loading the food product into a housing structure, wherein the housing structure has at least one baffle that causes the food product to rotate as the housing structure is agitated; introducing treatment composition into the housing structure to contact the food product; wherein the treatment composition on the food product is no more than 5 wt % based on the combined weight of the food product and the treatment composition in the housing structure; and wherein at least 90% of the surface area of the food product is coated with the treatment composition as determined by % Surface Coverage Test.

In one aspect, a method and means is provided for applying a controlled amount of an antimicrobial solution on a food product using a pulsed application through spray nozzles while tumbling the food product.

In one aspect, a method is provided for coating material which is economical to manufacture, and efficient and durable in use.

As used herein, “treatment composition” refers to, as some examples, an treatment composition comprising antimicrobial agents (including antibacterial agents, fungicidal agents, disinfectants), preservatives or mixtures thereof, where the treatment composition may be in the form of a liquid or fluidizable solids. “Fluidizable solids” refers to a collection of solid particles that can be placed into a fluid-like motion and transported accordingly.

“Antimicrobial” means an agent adapted to kill or otherwise deactivate microbes such as viruses, bacteria, fungus, as well as nematodes and other parasitic organisms.

“Fungicide” means an agent adapted to kill or otherwise deactivate fungi and molds.

“Microorganism” or “microbe” includes bacteria, yeast, mold, fungi, protozoa, mycoplasma, as well as viruses.

As used herein, “a,” “an,” “the,” “at least one,” and “one or more” are used interchangeably. Also herein, the recitations of numerical ranges by endpoints include all numbers subsumed within that range (e.g., 1 to 5 includes 1, 1.5, 2, 2.75, 3, 3.80, 4, 5, etc.).

The above summary of the present invention is not intended to describe each disclosed embodiment or every implementation of the present invention. The description that follows more particularly exemplifies illustrative embodiments.

### BRIEF DESCRIPTION OF THE DRAWINGS

FIG. 1 is a side view of a housing structure of the present invention.

FIG. 2 is an end view of one embodiment of a housing structure of the present invention.

FIG. 3 is a cross sectional side view of one embodiment of a spray nozzle system in a housing structure of the present invention.

FIG. 4 is an end view of one embodiment of a housing structure of the present invention.

FIG. 5a is side view of one embodiment of a baffle of the present invention.

FIG. 5b is side view of one embodiment of a baffle of the present invention.

FIG. 6 is a perspective view of one embodiment of housing structure of the present invention.

FIG. 7 is a perspective view of one embodiment of a housing structure of the present invention.

### DETAILED DESCRIPTION OF ILLUSTRATIVE EMBODIMENTS OF THE INVENTION

Methods for applying antimicrobials or other active agents onto food products, and particularly meat products, are described. When applied to meat, the meat can be any type, including but not limited to beef, pork, or poultry, and may be in different forms such as carcass, subprimals, trim, coarse or fine ground or processed meats. In particular, processing large quantities of meat, whether in the form of carcass, subprimal, trim or during or post grinding, is difficult to integrate with a coating method to provide a uniform application of a treatment composition, such as an antimicrobial fluid. The present invention presents methods to apply a controlled amount of treatment composition to the food product in an efficient fashion so that an excess of the solution is not required to achieve a desired antimicrobial kill, resulting in an efficient and cost-effective application of composition.

In a number of embodiments, the treatment composition is applied as a spray while the food product or parts thereof are conveyed from the inlet end to the outlet end of a housing structure. Food products that may be treated include: meat, meat parts, seafood in whole form or in parts thereof, and fruits and vegetables in whole form or in parts thereof. As used herein, “meat” means fresh meat from animals of the red meat variety (e.g., beef, lamb, venison, etc.) or of the white meat variety (e.g., poultry, pork, etc.). Also, as used herein “seafood” means fish or shellfish. Typically, where treatment compositions are antimicrobials, they are applied in spray form to the surfaces of meat, poultry, or seafood in an effective quantity, i.e., so as to substantially reduce or eliminate populations of bacteria found on the surfaces. Typically, disinfecting or fungicidal fluids are likewise applied to the surfaces of fruits and vegetables in amounts that substantially reduce or eliminate populations of bacteria or fungi found on the surface.

In the methods provided, food products are continually mixed and optimally exposed to the treatment composition in intervals (e.g. in spray pulses) such that the amount of fluid applied is kept within a narrow range for specified intervals of time, resulting in a coating that preferably adheres firmly and evenly to the food products. However, a combination of factors contributes to the effectiveness of this invention, including: the dimensions of the drum; the size, shape, and positioning of the baffles; the positioning and spray pattern of the coating liquid nozzles, and relative timing of the treatment composition applied. All of these features help to ensure that product is always in motion, and optimally exposed on its surface area when exposed to the treatment composition.

In contrast with known methods of application (i.e. dipping, spraying on a conveyor belt), the present method is capable of applying small, controlled quantities of antimicrobials uniformly across the surface of a food product. This may be critical when applying antimicrobial compounds that at higher levels can detrimentally effect the organoleptic properties of the food (e.g. color, taste, texture, odor, etc.) The methods employed also provide enhanced mechanical contact or friction across the surface of the food products which can be particularly effective in achieving good antimicrobial activity.

One embodiment discloses a method for treating food products or parts thereof comprising the steps of: introducing the food products into the inlet end of an housing structure, and applying, for example as a spray, an effective amount of a treatment composition onto the surfaces of the food products, as the latter are being conveyed, while agitated and tumbled, from the inlet end to the outlet end of the housing structure, so as to improve the edibility, longevity, and/or appearance of the treated food products without adversely affecting the organoleptic properties of the food product. Preferably, the food product is tumbled for an additional period after the treatment solution has been fully dispensed.

Embodiments of the present invention allow an effective quantity of a treatment composition to be applied to substantially the entire surface of food products. Preferably, greater than 90% of the surface of the food product is covered, more preferably greater than 92%, even more preferably greater than 95%, even more preferably greater than 97% and most preferably greater than 99% of the surface area of the food product is covered as measured by the Surface Area Coverage Test described below. Surface coverage by the treatment composition is achieved by direct contact between the food surfaces and sprayed fluid; by contact between the food surfaces and other food surfaces having sprayed fluid contained thereon; and by contact between the food surfaces and various housing structure surfaces (e.g., housing structure, baffles, etc.) having sprayed treatment composition contained thereon.

A number of specific details of certain embodiments of the invention are set forth in the following description and figures to provide a thorough understanding of such embodiments. One skilled in the art, however, will understand that the present invention may be practiced by way of additional embodiments or in the absence of some of the limitations set forth in the embodiments described below.

### Treatment Compositions

Suitable treatment compositions include antimicrobial compositions that include but are not limited to oxidizing agents such as acidified sodium chlorite solutions, aqueous chlorine dioxide solutions, per-acid solutions, hydrogen peroxide, chlorine compounds such as hypocholite, metal hypohalites, electrolyzed water, super oxidized water, ozone solutions; quaternary ammonium surfactant compounds; organic carboxylic acids such as GRAS or food grade acids including but not limited to citric acid, lactic acid, malic acid, acetic acid and the like; phenol and cresol compounds; halogens and halogenated compounds such as iodine, iodine liberating compounds and complexes such as iodophors, and compounds comprising covalently bound iodine, chlorine, bromine, chlorine or bromine liberating compounds and complexes, and compounds comprising covalently bound chlorine or bromine; natural plant or animal extracts such as grapefruit seed extract and tea tree oil; enzymatic products, surface-active agents, parabens, alcohols, solutions of heavy metals, chlorhexidine, peroxygen compounds, triazines, and aldehydes, and fatty acid monoesters in any of its various formulations, such as those described in U.S. Pat. Nos. 5,460,833; 5,490,992; 6,365,189; 6,534,075; 5,364,650; 5,436,017 and U.S. Publication No. 05-0053593-A1; as well as active derivatives and/or combinations of all of the above. In a preferred embodiment, the antimicrobial active in the treatment composition is less than 6 wt %.

In a preferred embodiment, the applied antimicrobial compositions contain fatty acid esters, an enhancer, food grade surfactants and optionally other ingredients as described in U.S. Publication No. 05-0084471-A1. These components may be formulated as concentrated compositions using propylene glycol fatty acid monoesters as both solvent and active ingredient. The resulting formulation can be either directly applied to the food or preferably applied as a dilution of the concentrate in water or other solvents with an enhancer soluble, emulsified, or uniformly dispersed in the dilution solvent. The formulations are preferably effective against pathogenic and undesired bacteria and do not detrimentally alter the taste, texture, color, odor or appearance of the food products.

Treatment compositions comprising at least one surfactant can assist in increasing the application efficiency. Preferably a food grade surfactant is used. Suitable food grade surfactants include those listed in Code of Federal Regulations (CFR) 21 Parts 170 to 199. A particularly preferred surfactant is docusate sodium. Preferred treatment solutions have a surface tension of less than 70 dyne/cm, preferably less than 60 dyne/cm, more preferably less than 50 dyne/cm and most preferably less than 40 dyne/cm, e.g. less than 35 dyne/cm.

The treatment composition is usually liquid at ambient temperatures, and may consist of a single component but will generally comprise two or more components, being in the form of an emulsion, dispersion, slurry or solution. Certain compositions such as liquid or solid coating materials may be applied at an elevated temperature (above melting point) for ease of application. For example, compositions comprising one or more components that is a solid at room temperature can be applied at a temperature above the melting point of one or more of the solid components. Alternatively, these materials can be emulsified into water and applied as an emulsion. For coatings that contain solid materials, spray nozzle(s) must be used which provide a reliable spray performance.

The compositions applied generally have viscosities ranging from 1 to 100,000 cps or more. Preferably, the compositions have a viscosity less than 1000 cps when applied and more preferably less than 100 cps. The vehicle for the composition is preferably water but may be any acceptable vehicle, such as supercritical carbon dioxide and the like. The viscosity of the coating material may be such that pumping is difficult at ambient temperatures, in which case the coating material may be heated to a temperature at which its viscosity is sufficiently low to enable it to be pumped to the spray dispensing nozzle(s).

Methods of Applying Treatment Compositions

The methods of the present invention apply the minimum effective amount of treatment composition to the surface of the food product uniformly to ensure higher antimicrobial efficacy with increased coating efficiency, i.e., minimizing waste. Coating efficiency as used herein refers to the amount of treatment composition applied through the fluid delivery system (i.e, spray nozzles), minus the amount recovered from the housing structure after treatment of food product, and divided by the amount of treatment composition applied through the fluid delivery system (i.e, spray nozzles). Preferably, the methods of the present invention have coating efficiencies preferably greater than 60%, more preferably greater than 70%, and even more preferably greater than 80%.

Waste may be a problem with many antimicrobials due to low pH or other environmental concerns, which may require that the excess treatment composition be treated prior to sewering or other more expensive disposal method. Ideally, no waste is generated in the methods of the present invention.

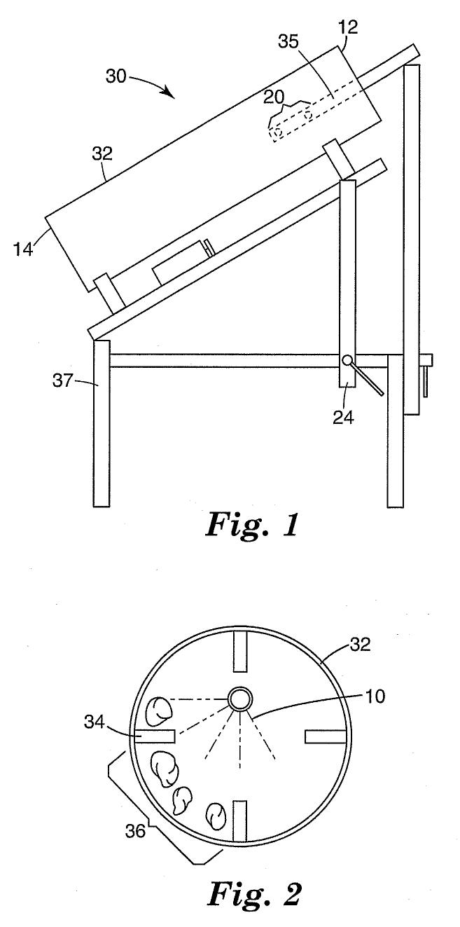

In one embodiment, food products, such as meat parts, or such as seafood, vegetables, or fruits, in whole form or in parts thereof, are first introduced into the inlet end 12 of a housing structure 30, such as drum 32, as shown in FIG. 1. While the food products are being conveyed, they are sprayed with a treatment composition delivered from a plurality of spray nozzles 20.

The drum 32 may be operated in a continuous or batch mode. In a first embodiment using a continuous coating operation, the housing structure 30 includes an elongated cylindrical drum 32 having an upper inlet end 12 and a lower outlet end 14 for flow through of the food product. In a second embodiment using a batch coating operation, the drum can have one open end (not shown) for loading and unloading food product.

In both the continuous and batch operations, the drum 32 is mounted on a frame 37, with the angle of tilt of the drum preferably being adjustable, as shown in FIG. 1. The drum is operatively connected to a motor (not shown) for rotating the drum about the tilted axis. A fluid delivery system comprising a spray bar 35 having a plurality of spray nozzles 20 mounted thereon extends into the drum. A liquid treatment composition is sprayed from the nozzles 20 as the drum 32 rotates, thereby coating the surface of the food product while agitated and tumbled in the drum 32. With multiple nozzles, one or more liquid treatment compositions may be sprayed from the nozzles 20 so as to coat the food product as the drum 32 rotates.

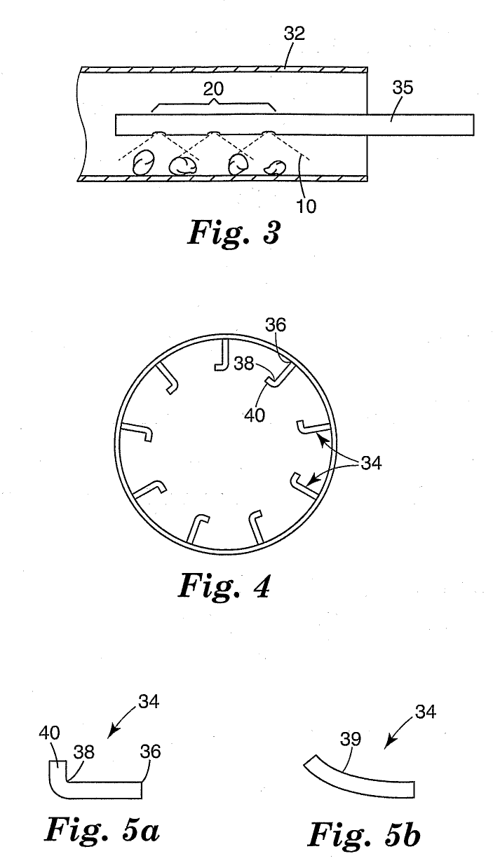

With efficient product mixing action in the drum 32, very uniform coating can be achieved without damaging the product due to excessive rotations of the drum 32. A typical configuration would consist of one or more spray nozzles 20 mounted near the centerline of the drum, as shown in FIGS. 1 and 3, with the spray nozzles 20 targeting the falling product. Many spray patterns can be used including a simple open ended pipe through to flat, hollow cone, square, full cone and spiral nozzles.

A spray boom or bar 35 can be used that is fixed or removable such as slidably extendable into and out of the drum 32. The spray bar 35 may be centrally positioned within the drum 32 as shown in FIG. 1, or can be positioned off center as shown in FIG. 2, to accommodate the spray pattern of the spray nozzles 20 for efficient coverage of the food product. In certain embodiments (not shown), more than one spray boom 35 may be employed.

In the drum 32 shown in FIG. 3, a plurality of spray nozzles 20 are spaced along the boom 35. The nozzles 20 can also be interconnected by a series of tubes or hoses. The spray nozzles 20 operate in a conventional manner to spray the treatment composition onto the food product passing through the drum 32. In an exemplary embodiment, the spray location is located at the inlet end 12 of the housing structure where the food product is introduced and at optimum points along the length of the drum 32 (i.e., where the baffles 34 will cause a rotation of the food product, such as meat trim), as shown in FIG. 3.

In one embodiment, one or more concentric air/liquid spray nozzles are used. Pressurized liquid and/or pressurized gas pass through the nozzles to control droplet size and velocity in the resultant spray from the nozzles. A concentric spray nozzle generates a relatively fine spray of liquid that can be directed at the food product. In an alternative embodiment, the treatment composition may be delivered as a foam.

In another embodiment the treatment composition can be delivered by spraying the drum 32, which subsequently contacts the food product. In another embodiment the treatment composition can be delivered into the drum 32 by means other than spraying. For example, the treatment composition could be pumped into the interior of the drum 32 as a liquid or foam directly onto the food product or onto the drum 32 in a contact method (e.g. such as through a brush, foam, or wiped film applicator) or a non-contact method such as allowing it to fall onto the food product and/or drum surface. Combinations of these methods are also contemplated.

A presently preferred method is to apply the treatment composition to the food product as a spray. In this method, a concentric nozzle is convenient because air pressure draws the fluid to be atomized through a venturi effect. One advantage to the geometry of this style of atomizer is that liquid is passively drawn into the system, with no need for an active pump, and there is no re-circulation of liquid as in some other aerosol generators.

However, other means can be used to generate the spray such as an atomizer using pressurized liquid forced through a spray nozzle. This method allows a wide variety of spray patterns to be created. Also a combination of pressurized gas and pressurized liquid can be used to create a spray through a suitable nozzle, which may provide more control of spray pattern, and determine droplet size and velocity. The spray velocity is preferably controlled to minimize scatter or rebound of liquid off the food product surface due to re-aerosolization of spray after hitting the surface of the product or housing structure. In a preferred embodiment, the spray is provided at low velocity, i.e., 2 meters/sec or less, with a sufficient droplet size (i.e., 10-1000 microns) to effectively deposit on the desired surface area.

Droplet size of the droplets may contribute to the effectiveness of the treatment composition delivery. Droplet size can be controlled by the combinations of spray system used, spray nozzle geometry, physical characteristics of the fluid, appropriate combinations of fluid and gas flow rates, and control of the environment through which the spray is delivered. In a preferred embodiment, the droplet size is less than 1000 microns, more preferably less than 600 microns, even more preferably less than 200 microns. In other preferred embodiments, the droplet size is greater than 10 microns, more preferably greater than 30 microns.

To ensure rapid and even coating, the antimicrobial solution is generally sprayed at a product target area, shown as spray zone 36 in FIG. 2 at the point where the food product is proceeding through its rotation off the baffle 34 generally about 5-90 degree of rotation from the bottom of drum 32. In order to expose new surfaces to the spray, the baffles 34 pull pieces of food product away from the bottom of the drum 32, present in bulk, and redeposit them on the top of the food product bulk. During this process, uncoated surface area on the food product is exposed and sprayed with the treatment composition.

For viscous coatings, air atomization nozzles may greatly improve the coating quality, by producing droplets of coating much smaller than is possible using hydraulic atomizing nozzles at low to medium pressures but high velocity. The small droplets possible with air atomization enable thin, uniform coatings to be produced when the viscosity of the coating material is high.

In an exemplary embodiment, the treatment composition is sprayed on the food product using pulse intervals. By timing the spray pulses at a set flow rate, the amount of treatment composition can be applied in a controlled manner to the optimum exposed surface of the food product (i.e., as the food product is rotating off a baffle) and limit or control the total amount of antimicrobial solution applied to the food product surface while achieving surface coverage (i.e., preferably greater than 90%). To improve surface coverage in a short period of time, the spray pulse intervals should be designed to spray on the food product as the food product is rotating off the baffle 34 as shown in FIG. 2.

The amount of treatment composition applied results in an application amount, defined as the weight % of treatment composition applied to the food product based on total weight of the food product. In a preferred embodiment, the application amount is no more than 5 wt %, preferably less than 3 wt %, and more preferably less than 2 wt %, even more preferably less than 1.5 wt % and even more preferably less than 1.25 wt %. Application coverage is the amount of treatment composition applied per surface area of food product. Preferably, the methods of the present invention have an application coverage of the treatment composition of 0.01 gm/cm̂2 with a 2 wt % application amount.

Alternatively, both the application amount and the application coverage can be quantified based on the wt % of antimicrobial active rather than the weight of the total treatment composition. In a preferred embodiment, the application amount based on antimicrobial active is no more than 0.30 wt %, more preferably less than 0.18 wt %, and even more preferably less than 0.12 wt % based on the weight of the food product. Preferably, the methods of the present invention have an application coverage of 0.0006 gm/cm̂2.

Use of a pulsing/intermittent delivery of the treatment composition provides a way to limit the quantity of treatment per weight of product by maximizing the surface area covered with a minimum amount of material. This can be particularly beneficial for those food products, such as meat, that are restricted in weight gain by USDA regulations, such as those provided FSIS directive 6700.1, 9 CFR/441.10. In those instances in which excess treatment composition is applied (i.e., greater than 2 wt % based on the total weight of the food product), excess can be removed by other means such as natural evaporation, forced evaporation with heat, air flow etc, or force a sublimation such as by adding carbon dioxide.

In one specific embodiment, the plurality of spray nozzles 20 may be configured to deliver a spray in the form of a fog or mist. In another specific embodiment, the plurality of spray nozzles 20 may be configured to deliver a full cone-shaped spray. In another specific embodiment, a fan-shaped spray may be delivered. In yet another specific embodiment, for a given housing structure, some of the spray nozzles 20 may deliver a spray as a fog or mist, some may deliver a full cone-shaped spray, and some a fan-shaped spray. Also, in one embodiment of this invention, all of the plurality of spray nozzles 20 deliver about the same flow rate of treatment composition, while in another embodiment, the spray nozzles located closer to the inlet end 12 deliver a higher flow rate of fluid than that delivered by the spray nozzles located closer to the outlet end 14.

In an alternate embodiment, a high velocity, low pressure (HVLP) method may be used with the spray nozzles. High velocity, air assist nozzles, which can be either reusable or disposable, atomize the sprayed material in very small particles sizes, and may effect penetration of the food product surface, using a high velocity air stream.

In another embodiment, electrospraying and means for controlling liquid feed rates, such as a positive displacement pump or a pressurized vessel as described below, may be used. The use of an electrospray can also be an effective spraying approach for a solution with the appropriate charge characteristics. Electrospray provides a spray that has an electrical charge of a certain polarity, and by providing a charge of opposite polarity to the food product surface, the spray may be more efficiently deposited onto the surface.

A variety of methods for controlling liquid feed rate and air pressure can be used, including pressure pots, critical orifice flow control systems, positive displacement pumps and the like for liquid flow, and standard regulated pressure systems for the gas flow.

In addition to a plurality of spray nozzles 20, one or more spray nozzles may be incorporated into components of the food handling or food processing equipment (including but not limited to an auger or tumbler) that transports food product, such as meat, through and between various processing stations, the walls of the containers through which the food product is conducted, (such as the dies through which the meat is ground), and other processing machinery which comes into close contact with food product.

Alternatively, a spraying compartment may be added to spray the food product before the food product enters the housing structure 30. This spraying compartment can be configured to provide uniform coverage of spray as described above before the food product is introduced into the housing structure 30.

In yet another embodiment, the fluid delivery system can be adapted to apply different types of treatment compositions to a particular food product as the product is conveyed from the inlet to the outlet of the housing structure. The different types of treatment compositions may be applied sequentially or simultaneously. As one example, for embodiments where the fluid delivery system has one or more manifolds, the fluid delivery system may apply one type of treatment composition as the food products are initially conveyed away from the inlet 12. Then, by means of a switching valve or similar device, another type of treatment composition may be delivered to the manifold(s) and applied to the food products as the latter are further conveyed toward the outlet 14. As another example, for embodiments where the fluid delivery system has two manifolds, as food products are conveyed from the inlet 12 to the outlet 14, one type of treatment composition is delivered to one manifold and applied to the food products, and, at the same time, a different type of treatment composition is delivered to the other manifold and applied to the food products.

In some embodiments, individual components (e.g., fatty acid monoesters, an enhancer, food grade surfactants etc.) of a given formulation can be separately applied onto the food, which may provide additional benefits by more effectively coating or “priming” the surface of the food product by one component, followed by the addition of other components to render the formulation more effective. For example, in one preferred formulation, an enhancer, such as dilute malic acid is applied first, followed by a surfactant such as DOSS and/or the fatty acid monoester. This approach may also be used to combine spraying of components with dipping into or bulk addition of other components.

Referring back to FIG. 1, drum 32 can be slightly inclined from the horizontal so that product loaded into the drum 32 at inlet 12 gradually moves along the tumbler to the outlet end 14, thus forming a continuous operation. Alternatively, in a batch mode the drum 32 can be horizontal so that the drum can be loaded and unloaded via a single opening (not shown). The rotation of the drum 32 continually agitates and mixes the product as it moves through the drum 32 and towards outlet end 14. In another configuration (not shown), the outlet end 14 may be elevated in relation to the inlet end 12.

The drum 32 can be rotatably supported by a plurality of trunnion wheels for rotation about its longitudinal axis by a chain or belt drive (not shown). At least one of the trunnion wheels is a drive wheel operatively connected to a motor (not shown) for rotating the drum 32. Alternatively, the drum 32, may be supported by an integral shaft which is mounted in a bearing and further comprises a gear that is driven by a chain. The tilt of the drum can be adjusted by a jack 24 or other adjusting means such as hydraulics.

In a specific embodiment, the housing structure 30, i.e., drum 32, provides exposure of all surfaces of the food surface through a combination of a system of baffles 34 within the drum 32, as shown in FIGS. 2 and 4. As used herein, a “baffle” is a rib or ridge that projects from the interior surface of the drum 32.

In an exemplary embodiment, the baffle 34 runs the length of the drum 32 and is substantially parallel with the axis of the drum 32, although numerous baffle geometries are possible. As the drum 32 rotates, the baffle 34 lifts the food product such as meat trim and causes the food product to rotate as it falls off the baffle 34, as shown in FIG. 2. In this manner, the food product, such as meat trim, is forced to contact other food product. While not intending to be bound by theory, this friction or abrasion may contribute to higher bactericidal activity.

As the drum 32 rotates in a clockwise position, the material is tumbled in the six o'clock- to eleven o'clock and preferably six o'clock to nine o'clock region of the drum 32 and coated with treatment composition from the spray nozzles 20, as shown in FIG. 2. Regardless of rotational direction, the food product is lifted up by baffle 34 generally between some 5 to 150 degrees of rotation from the bottom of the drum 32, and preferably between 10 and 90 degrees of rotation from the bottom.

The drum 32 is rotated at approximately 8-35 rpm, depending on the desired flow rate of the food product. Drums of different geometries will be rotated at different speeds and could be outside this range. The critical feature is that the food product (such as meat trim) has proper turn over of new surface area exposed to the spray without causing perceptible damage to the food product.

As used herein, tumbling rate refers to the number of times per minute the food product encounters, or comes in contact with, a baffle. The number of encounters is determined by the rotations per minute (rpm) of the housing structure multiplied by the number of baffles. Preferably, the tumbling rate is at least 4 encounters/minute, more preferably at least 48 encounters/minute, more preferably at least 120 encounters/minute, and even more preferably at least 180 encounters/minute. For example, a housing structure rotating at twelve RPM with four baffles would have a tumbling rate of 48 encounters/min. In many embodiments, the housing structure with the baffles is generally designed to achieve a tumbling rate of at least 48 (encounters per minute).

As the drum 32 rotates, the baffles 34 carry the food product upwardly from approximately 0-90 degrees of rotation from the bottom), as illustrated in FIG. 2. At approximately the 90 degree position, the material falls off of the baffles 34 so as to form a “wall” of food product that falls through spray zone 36. The nozzles 20 are directed toward the wall of food product in spray zone 36.

In a preferred embodiment as shown in FIGS. 4 and 5a, the baffles 34 have a proximate end 36 and distal end 38. The distal end 38 may have a projection 40 to ensure that the food product is (1) exposed to the spray nozzle (not shown) and (2) maintained in contact with the treatment composition for an effective period of time. Other means of maintaining the food product on the baffle 34 (as well as force the rotation of food product off the baffle 34) include one or more curves on the projection 40, and/or a convex or concave surface 39 of the baffle 34 as shown in FIG. 5b. Alternatively, the baffle 34 may have a textured surface to increase friction with the food product and thereby hold the food product in place for a longer period of time.

In one embodiment, the baffle system comprises four baffles 34 spaced equidistant at approximately 90 degrees apart within the cylindrical interior surface of the drum 32 and spanning the entire length of the drum (as shown in FIG. 2). Specifically, the baffles 34 induce a tumbling of food product proximate to and immediately below the spray nozzles. Thus, large continually moving layers or slabs of food product are exposed to the antimicrobial solution, during which time the food products are never stationary but move in a gravity driven cascade toward discharge and underneath the spray nozzles 20.

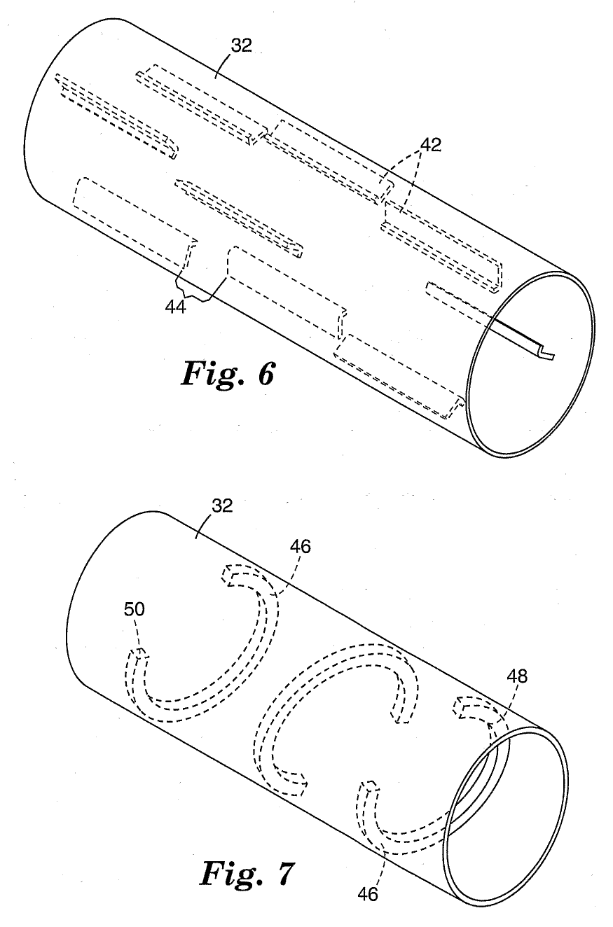

In an alternate exemplary embodiment shown in FIG. 6, the baffles contemplated are not continuous along the entire length of the housing structure, but are segmented in a discontinuous manner down the length of the drum 32. As shown in FIGS. 4 and 6, the drum 32 would rotate counterclockwise for the baffle segments 42 to pick up the food product as the drum 32 rotates. The baffle segments may be random throughout the drum 32 or segmented in a continuous line along drum 32. As shown, the baffle segments 42 are also offset from one another by a certain distance from the end of one baffle segment 42 to the beginning of the next to create an intermediate spray zone 44. The offset baffle segments 42 serve to provide an additional means to impart rotation to the product as it passes through the drum 32, reaches the end of the baffle segment 42 and falls towards the beginning of the adjacent baffle segment 42. In addition, by locating the spray nozzles such that the spray is directed at the intermediate spray zone 44 created at these segmentation points, the rotating and falling product is exposed on more sides to the treatment composition from the spray nozzles (not shown).

In another exemplary embodiment shown in FIG. 7, baffles 34 comprise a partial or complete inner ring around the inner circumference of the drum 32. By controlling the degree of completeness of the ring baffle 46, the food product will rotate off the first ring baffle 46 onto a second ring baffle 46 below and be subject to additional spraying on a freshly exposed surface. To aid in the timing and rotation of the food product off the ring baffle 46, as above for the baffle segments 42, the existence of a projection 40 (not shown) at the edges 48 of the ring baffle 46, including at the end 50 of the ring baffle 46, may be provided. The spacing of the ring baffles 46 and the height of the projection 40 will depend on the nature of the food product, the quantity of product, and the spraying system configuration.

In one embodiment, as the material reaches the outlet end 14 of the drum 32, the food product can accumulate in a discharge chute (not shown) until a sufficient quantity of material activates a door to open for discharge of the coated material. The food product is preferably in the drum 32 for at least 30 sec., more preferably at least 1 min., and even more preferably at least 2 min. during the coating process, though more or less time may be necessary for certain coating processes. Increased total tumbling time will increase the agitation of the food product, thereby increasing the total number of encounters. The total number of encounters can be calculated by multiplying the tumbling rate by the time the food product remains in the coating chamber. The total number of encounters is preferably 100, more preferably 500, and most preferably 1000. Tumbling time will also aid in efficiently distributing any excess antimicrobial solution applied to the surface of the food product. Increased contact allows more complete and uniform coverage of the surface of the food product.

While shown as a rotating cylindrical drum 32, the housing structure 30 may be of different geometric cross sections besides circular, such as elliptical or multilateral (i.e., polyhedron), with the number of sides depending on the application. Housing structure orientation may be at any angle from 0 to 90° from horizontal, with the baffle configurations changing accordingly.

As may be readily appreciated, the specific size of the drum 32 of the present invention may be varied without undermining effective functioning of the housing structure, as long as there is a corresponding change in the number and positioning of the baffles, as needed. The baffle geometries can also be optimized to most effectively tumble the product based on product size configurations. If the drum were made larger in diameter or longer, the baffles may require adjustment or increased number to ensure proper movement of the food product through the drum and toward the spray zone. In related embodiments, the baffles may have one or more protrusions attached thereto, as described above, and/or each of the plurality of baffles may have a bent distal end comprising one or more bends, as described above.

Furthermore, it may be preferred in many facilities with limited floor space to use a tumbler that has a substantially vertical axis. That is a system where the major axis of the equipment is greater than 45 degrees from horizontal (i.e., the plane of the floor) and preferably greater than 60 degrees from horizontal. For example, the ring baffles 46 may require a greater angle, i.e., greater than 45 degrees, to assist in the movement of food product between ring baffles 46. In such systems, the food product may be conveyed to the top of the unit and tumbled and sprayed on the way down to a receiving conveyor. Alternatively, the food product may enter the bottom and conveyed out the top so long as the food product is repeatedly agitated and in contact relative to the other pieces of food product, rather than simply pushed through the housing structure.

In some embodiments, the temperature of the housing structure will be dictated by the requirements of the coating material. Walls of the housing structure will preferably be kept cool in most embodiments. In some applications, the antimicrobial solution may be heated to impart a heat shock to the surface microorganisms when applied to the product surface. For example, compositions containing antimicrobial lipids may be heated to 40 deg C. and applied through the spray nozzles.

Other components of the processing can include a housing, control systems, etc as known in the art. A drying system may also be employed such as an air knife provided post tumbling to remove excess liquid.

Preferably, a computer or microprocessor is employed for controlling the operation of the process. For example, the computer may be utilized for controlling the electrical power to the drum 32, the tilting angle and rotation of the drum 32, the spraying function of the nozzles 20, the air flow and temperature in the drying system. The computer is operatively connected to an instrument panel, which has the appropriate electrical circuitry, control buttons and indicator lights, so that a person can start and stop the various functions of the process, and monitor its operation.

For embodiments of the present invention, the housing structure, the baffles, and the protrusions, if any, on the baffles are preferably made of metal, and, most preferably of stainless steel. In an alternate embodiment, the components may be made of high impact polymer, such as those described in U.S. Publication No. 2005/0058013 (Warf et. al).

### EXAMPLES

Objects and advantages of this invention are further illustrated by the following examples, but the particular materials and amounts thereof recited in these examples, as well as other conditions and details, should not be construed to unduly limit this invention. Unless otherwise indicated, all parts and percentages are on a weight basis, all water is distilled water, and all molecular weights are weight average molecular weight.

For all examples, unless otherwise noted, the antimicrobial composition was prepared by combining a concentrated mixture of fatty acid monoester and DOSS surfactant (A solution of 98 wt % propylene glycol monocaprylate available from Uniqema in New Jersey) and 2 wt % DOSS (dioctylsulfosuccinate sodium salt surfactant available from Cytec Industries in New Jersey) diluted in a solution of 2% malic acid in water in a ratio of 6:94 by weight. When combined with food dye, the antimicrobial composition was further combined with a 0.1 wt % dye. (FD&C #3, available from Noveon Hilton Davis, Inc., Cincinnatti, Ohio)

### % Surface Coverage Test

Meat trim was treated with either a 0.1 wt % or 0.5 wt % dye solution, or an aqueous antimicrobial composition that was mixed with a 0.1% dye solution, and removed from the tumbler. Where aqueous systems are used the dye should be FD&C #3, available from Noveon Hilton Davis, Inc. For systems where this dye is not compatible, a dye and dye concentration should be selected such that the coverage area is plainly obvious. This readily determined by one skilled in the art by repeating Example 1 below. The meat trim was laid out on a flat surface such that all pieces of meat trim were positioned closely adjacent to each other while taking care not to compress the food product (e.g. meat) and to minimize any open areas. Each piece of meat trim was examined by eye to determine uncoated areas. Each uncoated area was measured with a ruler and the area recorded. The edges of each piece were also examined, as well as any obvious crevices or folded regions. Only the projected area was used to calculate the total available area. The total projected area occupied by the closely adjacent trim pieces was also measured. After measuring all uncoated areas, the trim was turned over and the process repeated such that both sides of all trim pieces were evaluated. The % surface coverage area was calculated by subtracting the uncoated (i.e., without dye) surface area from the total surface area, dividing by the total surface area, and multiplying by 100.

### Examples 1-8

A series of experiments was performed using a four-baffle drum to study the coverage of a food dye (FD&C #3, available from Noveon Hilton Davis, Inc.) sprayed onto tumbled beef trim. For examples 1-6, the meat trim was tumbled in a drum with four baffles spaced at 90 degree intervals while pulse spraying with antimicrobial composition applied to the meat trim using two SS8 (Spraying Systems, Wheaton, Ill.) nozzles for a total application time of 30 seconds.

For example 7, the meat trim was tumbled in a drum with four baffles while pulse spraying with antimicrobial composition applied to the meat trim using two SS8 nozzles for a total application time of 60 seconds.

For example 8, the meat trim was tumbled in a drum with four baffles while pulse spraying with antimicrobial composition applied to the meat trim using two SS8 nozzles for a total application time of 90 seconds.

The results of the tests are provided in Table 1:

TABLE 1

| | | Total | | | | | | | |
|---|---|---|---|---|---|---|---|---|---|
| | | Dye | | | | | | Total | |
| | Meat | solution | Spray | | Number | | Interval | tumbling | % |
| | weight | applied | application | | of | Seconds | between | time | Surface |
| Example | (lbs) | (grams) | rate | | pulses | per pulse | pulses | (seconds) | Coverage |
| 1 | 15 | 68.1 | 496 | gm/min | 2 | 4 | 11 | 30 | 92.5 |
| 2 | 10 | 45.4 | 496 | gm/min | 3 | 2 | 8 | 30 | 96.8 |
| 3 | 20 | 90.8 | 496 | gm/min | 3 | 4 | 6 | 30 | 95.2 |
| 4 | 10 | 45.4 | 496 | gm/min | 1 | 5 | 25 | 30 | 93.3 |
| 5 | 20 | 90.8 | 496 | gm/min | 1 | 11 | 19 | 30 | 92.3 |
| 6 | 15 | 68.1 | 496 | gm/min | 2 | 4 | 11 | 30 | 89.1 |
| 7 | 25 | 227 | 458.8 | gm/min | 4 | 7 | 8 | 60 | 98.6 |
| 8 | 25 | 227 | 458.8 | gm/min | 4 | 7 | 16 | 90 | 98.9 |

The optimal combination of these parameters resulted in efficient coverage of tumbled trim, and no uncovered areas were seen other than in trim segments which were folded (i.e., membraneous components).

### Examples 9-20

### Preparation of Culture Suspension

Trim was inoculated with bacteria containing three E. coli 0157:H7 isolates (20644 CSA, RC43R and K20; all obtained from Cargill Inc., Wayzata, Minn.). The bacteria were grown in Tryptic Soy Broth (TSB) (available from VWR Scientific, Chicago, Ill.) at 35° C.±2° C. for 16-24 hours. A 0.3 ml of organism culture suspension was spread on the surface of Tryptic Soy Agar (TSA) plate that was incubated at 35° C. for 16-24 hours. Bacterial cells were harvested from the agar plate with an L-rod by adding 1-3 ml of TSB and transferred to a test tube.

Inoculation of Meat Pieces with Bacterial Inoculum Cocktail

Several meat pieces 2 inch×2 inch×6 inch (5 cm×5 cm×15 cm) in size were inoculated. The samples were placed on a 8 inch×11 inch tray and inoculated with the inoculum cocktail by spraying 1 stroke of cocktail solution on to the meat pieces from a hand pumped spray bottle sufficient to wet the surface completely. The tray of meat samples was placed in 40° C. oven for 20 minutes.

### Determination of Inoculated Meat Bacterial Count

Three inoculated meat samples were each placed in a 3M Stomacher bag (obtained from 3M Co., St. Paul, Minn.) to which 99 ml. of Butterfields Buffer (available from International Bio Products, Bothell, Wash.) was added. The bags were stomached for 30 sec. to assist with removal of bacteria from meat. An aliquot (11 ml.) was removed from each sample bag and another 99 ml. Butterfields Buffer was added, mixed thoroughly to give a solution for further testing. Petrifilm™ E. coli/Coliform count plates (available from 3M, St. Paul, Minn.) were used as media with serial ten-fold dilutions using Butterfield buffer. Plates were incubated for 18-24 hours at 37° C. after which time they were counted as described below to give an initial bacteria count.

For the initial inoculum, plates with the colony forming units (CFU) were counted on the dilution level that had counts between 25-250. The average of the two duplicate plates at the selected dilution level was used. The initial inoculum count was calculated using the following formula:

Initial inoculum count=Tₜᵢₘₑ₌₀=Average CFU of 2 replicates×[dilution level]×0.005

(Since the sample inoculums were diluted (0.1 ml in 20.1 ml FAME)

The CFU's were counted on all the 10⁻² and 10⁻³ plates. The dilution level that has counts between 25-250 was determined and used. The average of three duplicate plates at the selected dilution level were used to calculate the test plate count at the given time using the following formula:

Tₜᵢₘₑ₌ₓ=Average CFU of 3 replicates at given time x[dilution level]

Average plate count of 3 replicates at exposure time point.

The log reduction was determined by taking the logarithm of Tₜᵢₘₑ₌ₓ. and Tₜᵢₘₑ₌₀ and using the following formulas to determine log reduction:

Log reduction at x time point=log Tₜᵢₘₑ₌₀−log Tₜᵢₘₑ₌ₓ

Treatment with Antimicrobial Composition

Inoculated trim was tumbled in a Lance tumbler, Model LT-5. Twenty-five pounds of trim from a packing plant (Dakota Premium Foods) were obtained and cut to approximately 2 in×2 in×6 in pieces. The antimicrobial composition was applied to the trim by using a series of spray pulses during tumbling. The pattern was 7 seconds spray, followed by 8 seconds of no spray, and this was repeated 4 times for a total of 28 seconds spray and 32 seconds without spray. Tumbling occurred at the same rate for the 60-second study time. The spray application rate was 458 gm/minute, and the total amount of applied antimicrobial was:

(458 gm/min)×(28 seconds)×(1 minute/60 seconds)=214 gm.

The trim weight was 11513 gm for low (Examples 9, 11-20) and high (Example 10) inoculum. The application amount was approximately 1.9% by weight.

Two kilograms of antimicrobial solution was made in a large 4 L beaker. The solution was stirred with a magnet using the Fisher (Hampton, N.H.) Thermix at a setting of 9 for at least 5 min. Using sterile tweezers, inoculated trim pieces was weighed out to determine the pre-treatment weight and transferred to the tumbler for spray treatment.

Spraying was accomplished by using a pressure pot (stainless steel pressurized vessel) that contained the antimicrobial formulation and a stir bar, to which is attached a regulated pressure line from the in-house pressure system, and from which is attached the spraying hardware. Two hollow cone nozzles (Spraying Systems, Wheaton, Ill.) 1/4M-SS8) were spaced about four inches apart and centered on a spray bar. The spray bar is offset inside the tumbler and supported by a pin which rests in a hole drilled through the rear of the tumbler and is also supported on a rubber gasket centered on the front cover of the tumbler. Vice grips fastened onto a clamped ring stand are used to immobilize the spray bar as it exits the front cover, such that trim which may contact the spray bar will not move it. The nozzle spray bar system operates by liquid pressurization only.

Antimicrobial composition was mixed continually using a stir bar within the pressure pot, and setting the pot on a magnetic stirrer. A stirring rate of 600 rpm was used. The temperature of the antimicrobial solution, the drum, and the meat was room temperature.

| | | Delivery | Trim | |
|---|---|---|---|---|
| | Pressure | Rate | weight | Tumbler |
| Sprayer | (psig) | (g/min) | gain (%) | speed |
| Hollow cone nozzles | 10 | 458 gm/min | 0.9-low | Max |
| (Spraying Systems | | | | (20 rpm) |
| SS-8) on spray bar | | | | |

The post-treatment weight was determined for the trim to monitor the amount of antimicrobial retained by the meat. Trim pieces were stored for 1 h after antimicrobial treatment in the cooler (5 to 10° C.).

All 25 pounds of trim were coarse ground using a table top grinder (US Edge 12×½; ½″ plate) and received on five sterile aluminum pans. From each of the five pans of coarse ground meat, five random samples of approximately 150 g were fine ground using a table top grinder with ¼″ plate (DC 12×¼). A total of approximately 3800 g or 8 pounds of trim was fine ground and received on sterile ¼ sheet aluminum pans.

For the E. coli O157:H7 studies, the meat was divided into 3 batches, transferred to sterile aluminum foil, wrapped, labeled, and either stored in environment housing structures set at 0° C. and 4° C. or frozen for sampling. Samples were taken from the refrigerated or frozen ground meat packages and analyzed after a day.

Five samples of 25 g from each treatment was placed individually in a 3M Stomacher bag, and labeled accordingly. Following stomaching, appropriate dilutions were made and the samples plated and stored for appropriate time point analysis as described above. The pre-inoculation native level of bacteria was 1.1 log as determined using the procedure defined above.

TABLE 2
Enterobacteria Log Reduction

| | | Log |
|---|---|---|
| | Initial | Reduction |
| | Log | after |
| | inoculum | Treatment |
| Example | level | Day 1, 4C |
| 9 | 3 | 1.1 |
| 10 | 5.2 | 1.5 |
| 11 | 2.5 | 1.1 |
| 12 | 2.5 | 1.1 |
| 13 | 2.5 | 1.6 |
| 14 | 2.5 | 1.5 |
| 15 | 2.5 | 1.7 |
| 16 | 2.8 | 1.2 |
| 17 | 2.8 | 1.8 |
| 18 | 3.4 | 1.7 |
| 19 | 3.3 | 1.4 |
| 20 | 3.3 | 1.8 |

### Examples 21-24

A series of experiments was performed using a four-baffle drum to study the coverage of a food dye (FD&C #3, available from Noveon Hilton Davis, Inc.) sprayed onto tumbled beef trim. The meat trim was tumbled in a drum with four baffles while pulse spraying with antimicrobial composition applied to the meat trim using two SS8 nozzles for a total application time of 30 seconds.

The results of the tests are provided in Table 3:

TABLE 3

| | Pot | Meat | Dye | Spray | No. | Secs | Interval | Total | % |
|---|---|---|---|---|---|---|---|---|---|
| | pressure | weight | solution | application | of | per | between | tumbling | Surface |
| Ex | (psig) | (lbs) | wt % | rate | pulses | pulse | pulses | time | Coverage |
| 21 | 9 | 25 | 0.1 | 449 gm/min | 5 | 3 | 3 | 30 | 90.3 |
| 22 | 3.1 | 25 | 0.1 | 269 gm/min | 1 | 28 | 0 | 30 | 86.9 |
| 23 | 30 | 25 | 0.1 | 896 gm/min | 5 | 3 | 3 | 30 | 96.2 |
| 24 | 10 | 25 | 0.1 | 480 gm/min | 1 | 28 | 0 | 30 | 96.3 |

The data shows that the pulse improves coverage (by minimizing uncoated areas) at low application rates. For the given pulse intervals, an application rate of 2% provides improved surface coverage over a 1% application rate.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1-5. (canceled)

6. A method of treating food product with a treatment composition comprising:
loading the food product into a housing structure, wherein the housing structure has at least one baffle that causes the food product to rotate as the housing structure is agitated; and
contacting the food product with a treatment composition as the food product rotates;
wherein the treatment composition on the food product is no more than 5 wt % based on the combined weight of the food product and the treatment composition in the housing structure; and wherein at least 90% of the surface area of the food product is coated with the treatment composition as determined by % Surface Coverage Test.

7. The method of claim 6, wherein the treatment composition contacts the food product before the food product is loaded into the housing structure.

8. The method of claim 6, wherein the treatment composition contacts the food product as the food product rotates.

9. The method of claim 6, wherein the method has a coating efficiency of at least 60%.

10. The method of claim 6, wherein the food product is meat, processed meat, poultry, vegetables or fruit.

11. The method of claim 6, wherein the treatment composition is an emulsion.

12. The method of claim 6, wherein the baffle has a proximate end and a distal end, wherein the proximate end is attached to the interior wall of the drum and the distal end has a projection at an angle between 0 and 90 degrees in relation to a major surface of the baffle.

13. The method of claim 6, wherein the baffle extends along the length of the housing structure.

14. The method of claim 6, wherein the housing structure comprises two or more baffles with a proximate end and a distal end, wherein the proximate end is attached to the interior wall of the drum and wherein the distal end of one baffle is offset from the distal end of the another baffle to create a spray zone.

15. The method of claim 6, wherein contacting the food product comprises spraying the food product through a spray nozzle mounted on a boom removably extendable into the housing structure.

16. The method of claim 6, wherein the housing structure comprises a plurality of baffles spaced equidistant from each other and spanning the entire length of said drum from the inlet end to the outlet end;
wherein the baffle system rotates the food product toward the outlet end of said housing structure during processing and rotates the food product over the baffles and into a spray zone of treatment composition introduced by at least one spray nozzle.

17. (canceled)

18. The method of claim 6, wherein the baffle has a proximate end and a distal end; wherein the proximate end is attached to the interior wall of the drum and the distal end has a projection at an angle between 0 and 90 degrees in relation to a major surface of the baffle; and wherein projection at each distal end of the baffle holds food product for specified period of time while food product is exposed to the treatment composition.

19-22. (canceled)

23. The method of claim 6, further comprising the step of mechanically removing the treatment composition from the food product by one or more of spinning, shaking, vacuum removing, or subjecting the food product to the action of an air knife.

24. The method of claim 6, wherein contacting the food product comprises spraying the food product and the spraying is accomplished with a spray nozzle system that is adapted to apply more than one type of treatment composition in a sequential fashion to a food product.

25. The method of claim 6, wherein contacting the food product comprises spraying the food product and the spraying is accomplished with a spray nozzle system that is adapted to apply more than one type of treatment composition at the same time.

26-28. (canceled)

29. The method of claim 6, wherein the treatment composition is a fungicide.

30. The method of claim 6, wherein the housing structure is a drum.

31. The method of claim 6, wherein the method has an application efficiency of 0.01 gm/cm².

32. The method of claim 6, wherein contacting the food product comprises spraying the food product.

33. The method of claim 6, wherein contacting the food product comprises spraying the food product and wherein the treatment composition reduces the microorganisms on the surface of the food product by at least one log.

34. The method of claim 6, wherein contacting the food product comprises spraying the food product and wherein at least 1% of the total amount of treatment composition sprayed on the food product is delivered within one spray pulse interval.

35. The method of claim 6, wherein the housing structure has a tumbling rate of 4; and wherein contacting the food product comprises spraying the food product with a treatment composition in more than one spray pulse interval as the food product rotates.
